(19) United States
(12) Patent Application Publication
(10) Pub. No.: US 2016/0210612 A1
(43) Pub. Date: Jul. 21, 2016

(54) Rapid in Person Transactions Via Mobile Device

(71) Applicant: Mistral Mobile, Oulu (FI)

(72) Inventors: Timo P. Tervo, Oulu (FI); Ludwig Schulze, Forest Hills, NY (US)

(21) Appl. No.: 14/601,120

(22) Filed: Jan. 20, 2015

(51) Int. Cl. G06Q 20/32; G06Q 20/40

(52) U.S. Cl. CPC G06Q 20/3226; G06Q 20/405; G06Q 20/3278; G06Q 20/3255

(57) ABSTRACT

In some example embodiments, there may be provided a method comprising: detecting, by a merchant equipment including a mobile payment application, one or more consumer equipment; generating, by the merchant equipment including the mobile payment application, a view including one or more photos sent by the detected one or more consumer equipment, wherein each of the one or more photos represent a corresponding user of the detected one or more consumer equipment; receiving, by the merchant equipment including the mobile payment application, a selection of one of the one or more photos; and sending, by the merchant equipment including the mobile payment application, payment information corresponding to the selected photo to enable authorization of a mobile payment by a user corresponding to the selected one of the one or more photos. Related systems, methods, and articles or manufacture are also disclosed.

### FIELD

The subject matter described herein relates to mobile payments.

### BACKGROUND

Mobile payments made via cellphones and smartphones are becoming ubiquitous in many parts of the world. Specifically, a user of a cell phone may make purchases, replenish an account, pay bills, and perform other transactions via the cell phone.

### SUMMARY

Methods and apparatus, including computer program products, are provided for efficient and secure financial transactions, such as in-person purchases.

In some example embodiments, there may be provided a method including detecting, by a merchant equipment including a mobile payment application, one or more consumer equipment; generating, by the merchant equipment including the mobile payment application, a view including one or more photos sent by the detected one or more consumer equipment, wherein each of the one or more photos represents a corresponding user of the detected one or more consumer equipment; receiving, by the merchant equipment including the mobile payment application, a selection of one of the one or more photos; and sending, by the merchant equipment including the mobile payment application, payment information corresponding to the selected photo to enable authorization of a mobile payment by a user corresponding to the selected one of the one or more photos.

In some variations, one or more of the features disclosed herein including one or more of the following features can optionally be included in any feasible combination. The sending may include sending via a short messaging service the payment information. The merchant equipment including the mobile payment application may receive identifying information from the one or more consumer equipment. The identifying information may be received via short-range wireless communication. The short-range wireless communication may include at least one of Bluetooth, Bluetooth Low Energy, Near Field Communications, or WiFi. The merchant equipment including the mobile payment application may receive confirmation of payment via a short messaging service.

In some example embodiments, there may be provided a method including signaling, by a consumer equipment including a mobile payment application, a merchant equipment, to indicate a presence of the consumer equipment; sending, by the consumer equipment including the mobile payment application, a photo to the merchant equipment, wherein the photo represents a user of the consumer equipment; and receiving, by the consumer equipment including the mobile payment application, a request for authorization of a mobile payment, wherein authorization is requested of the user of the consumer equipment that corresponds to the sent photo.

In some variations, one or more of the features disclosed herein including one or more of the following features can optionally be included in any feasible combination. The signaling may include responding to a request for information from the merchant device. The signaling may be carried out via a short-range radio access technology. The short-range radio access technology may include at least one of Bluetooth, Bluetooth Low Energy, Near Field Communications, and WiFi. The request for authorization may be received via a short messaging service (SMS). The method may further include sending an authorization message to a mobile payment server to enable the authorization of the mobile payment. The method may further include registering with a mobile payment server by at least providing, via the payment application on the consumer equipment, identifying information and a password, the identifying information may include at least one of name, address, financial credentials, government identification number, birth date, mobile phone number, and a photo of a user of the consumer equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1A depicts an example a system for setting up a user profile and performing an in person customer verification, in accordance with some example embodiments;

FIG. 1B depicts an example of a data exchange during a user profile setup, in accordance with some example embodiments;

FIG. 1C depicts an example of a data exchange during a transaction using a mobile payment application and in person customer verification, in accordance with some example embodiments;

FIG. 2 depicts example views which can be presented on a consumer equipment and/or a merchant equipment when initially preparing to use in person customer verification, in accordance with some example embodiments;

FIG. 3A depicts example views which can be presented on a consumer equipment and/or a merchant equipment when using in person customer verification for performing a transaction, in accordance with some example embodiments;

FIG. 3B depicts a process at a merchant equipment for mobile payment processing based on photos, in accordance with some example embodiments.

FIG. 3C depicts a process at a consumer device for mobile payment processing based on photos, in accordance with some example embodiments.

FIG. 4 depicts an example of a consumer or merchant device, in accordance with some example embodiments;

FIG. 5 depicts an example process for encrypting messages, in accordance with some example embodiments; and

FIG. 6 depicts examples of key collections, key parts, symmetric keys, messages, and/or the like, in accordance with some example embodiments.

Like labels are used to refer to same or similar items in the drawings.

### DETAILED DESCRIPTION

Mobile payments systems may use short message service (SMS) to send and/or receive financial information. Moreover, SMS may be used, when a data connection, such as an Internet Protocol (IP) connection, is not available or allowed (for example, in some emerging markets, data connections may not be available or usage may be limited due to cost). At times, financial transactions on mobile payment systems using SMS may require manual entry of information. Manual entry of information, including customer and merchant information, may be slow and prone to errors.

In some example embodiments, the subject matter disclosed herein may provide a payment application that enables a customer to setup a user profile that associates his or her financial credentials with a photo and identifying information related to a consumer device, including a mobile phone or smart phone. The consumer device may have short-range wireless communication capabilities, for example Bluetooth, Bluetooth Low Energy, Near Field Communications (NFC), WiFi, and the like, capabilities, which can be used to provide identifying information related to the consumer device.

In some example embodiments, the subject matter disclosed herein may also provide the ability for a merchant using the payment application, on merchant equipment such as a computer, a tablet computing device, a smart phone, and/or the like, to submit payment requests for transactions with one or more customers based upon photos of the customers associated with their respective user profiles. Once the merchant equipment submits a payment request to a server, the server contacts a payment platform (for example, a financial institution) with the customer's financial credentials. The payment platform may then send a message of available funds to the server, and the server may in turn request authorization from the customer. The customer may confirm authorization for the payment. When authorized, the authorized payment information may then be sent by the server to the payment platform for fulfillment.

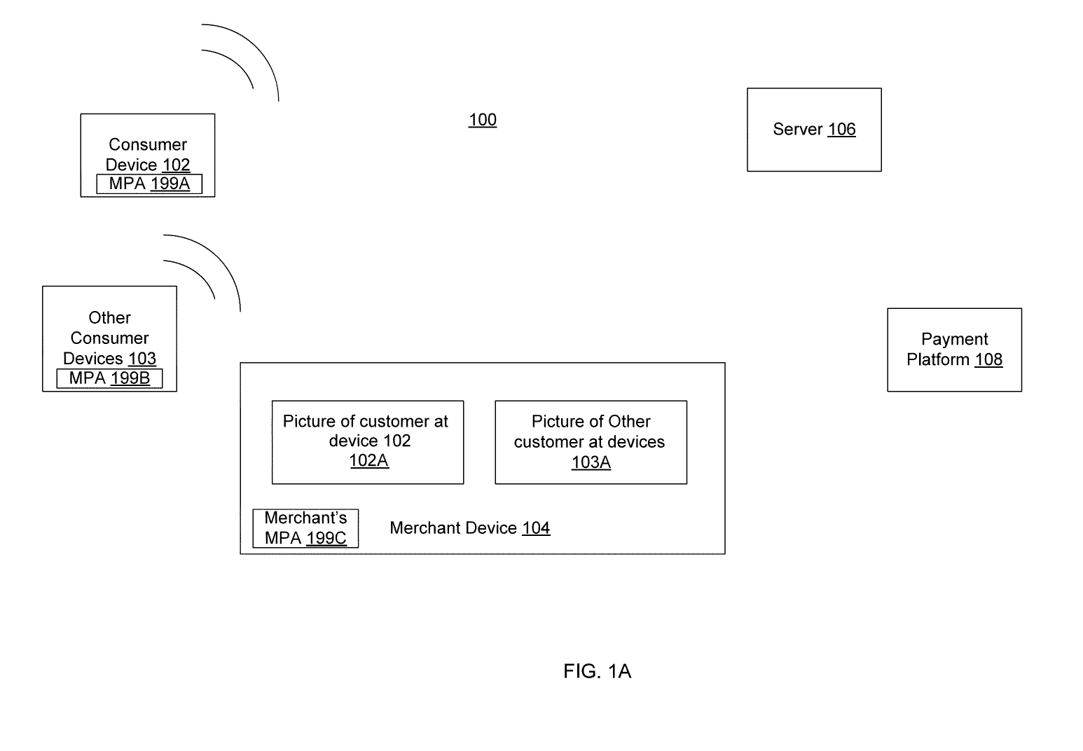

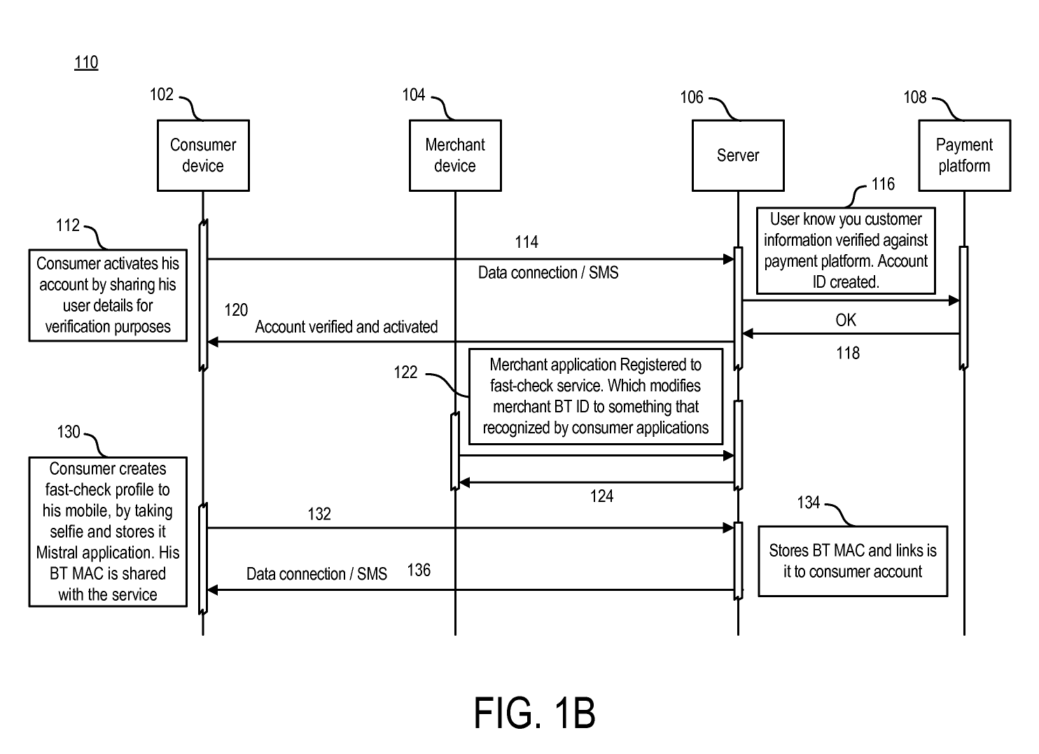

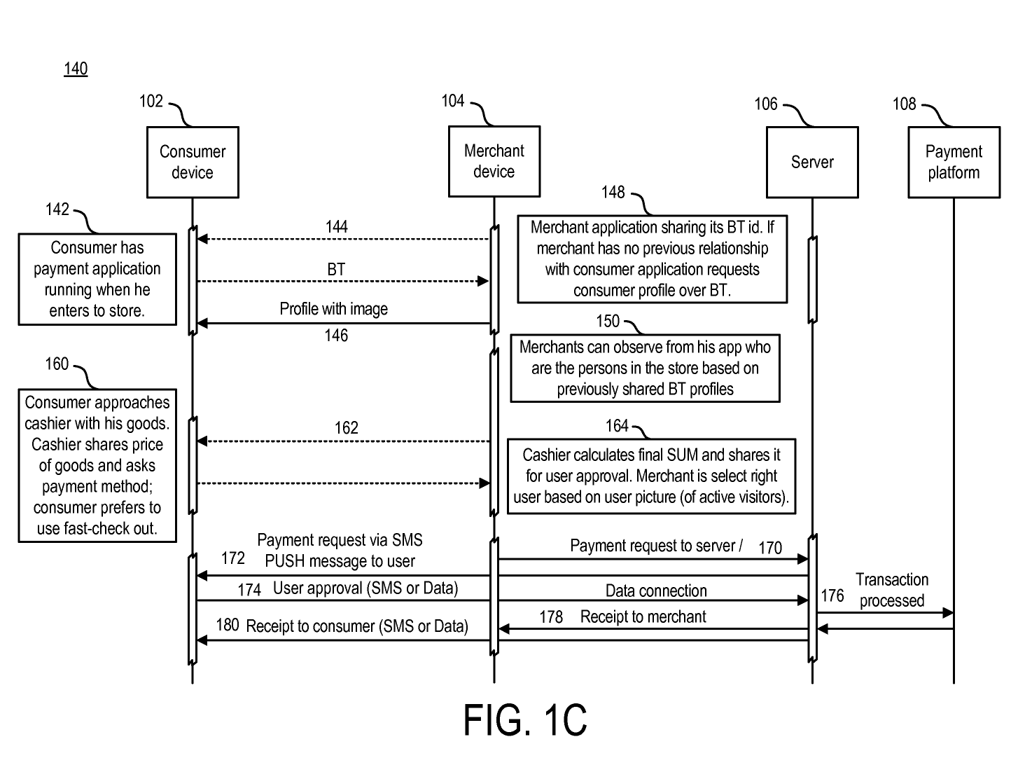

FIG. 1A depicts an example system 100 for mobile payment processing based on photos of the customer's faces, in accordance with some example embodiments. In the system 100, there may be one or more consumer devices 102, 103 that communicate with a server 106 and a merchant device 104. The system 100 may also include a payment platform 108 that communicates with the server 106.

Each consumer device 102, 103 and the merchant device 104 has a mobile payment application (denoted MPA in FIG. 1A). The MPA 199A on the consumer device 102 generates a user profile that is sent to and saved on the server 106. When a customer carrying the consumer device 102 walks into a merchant's store, the merchant device 104 may initiate communication with the consumer device 102 via a short-range communication protocol, for example, Bluetooth. The MPA 199C on the merchant device 104 may request information from the consumer device 102. The information requested by the merchant device MPA 199C may include a photo that is part of the user profile associated with the consumer device 102. The photo may be provided by the consumer device MPA 199A to the merchant device 104.

Other customers may enter the merchant's store with consumer devices 103. These consumer devices 103 may each have a mobile payment application 199B. The merchant device 104 may request information of the other consumer devices 103, as with the first consumer device 102. The other consumer devices 103 may also provide photos of the customers who own the devices to the merchant device 104 via Bluetooth or another short-range communication protocol.

After establishing communication with the consumer devices 102, 103, the merchant device 104 can display the photos of the customers that are provided by the MPAs 199A, 199B running on the consumer devices 102, 103. The merchant or an employee of the merchant can view the photos as pictures of the customers 102A, 103A via the merchant's MPA 199C on the consumer device 104. The merchant or employee can process transactions using the pictures of the customers 102A, 103A instead of user names or account numbers. After selecting a picture of one of the customers 102A, 103A, the merchant device 104 can communicate with the server 106 via the MPA 199C to complete the transaction.

The merchant device 104 may communicate with the server 106 using a short messaging system, a wireless communications method, and/or via a network, like the Internet. The server 106 may communicate with the payment platform 108 to provide the information needed to execute a payment transfer between the consumer and the merchant. In the system of FIG. 1A, the payment platform 108 may communicate only with the sever 106, and this communication may be via short messaging system, a wireless communications method, and/or via a network.

For example, a customer and a merchant may be located in an area where payment by cash or credit card is not accessible, desired, and/or convenient. The customer may have a consumer device, such as a mobile phone, smart phone, a tablet, and/or or other mobile processor-based device, that has a wireless transceiver, such as Bluetooth and the like. The customer may execute a mobile payment application 199A (labeled MPA) on the consumer device 102. The mobile payment application allows the consumer device to communicate with the merchant equipment that is also running a corresponding mobile payment application 199C (which may be configured for merchant use). Through the payment application, the merchant equipment can interface with a server, and in turn one or more payment platforms, to complete a transaction between the merchant and customer, for example the purchase of goods or services. In this example, the merchant equipment may include a laptop computer, a desktop computer, a tablet computing device, a smart phone, or any other processor-based computing device with a wireless transceiver (for example, Bluetooth and the like) to enable communications with one or more consumer devices.

The mobile payment application may be used to create a user profile for one or more customers. For example, the user profile information may include the user's name, address, financial credentials, identifying information (for example, government identification number, birth date, and the like), mobile phone number, a photo, a password, a personal account number (or a personal identification number) which can be used with the payment application during transaction authorization, and the like. The payment application may request or obtain information that identifies the customer's device (for example the media access control (MAC) address). The payment application may obtain this device information without active input by the customer (for example, automatically obtain a MAC address or other device identifying information). To illustrate further, a customer may, via a consumer device, opt-in to the payment application service and provide his or her user profile in order to utilize the payment service disclosed herein, although the user profile may be provided via any other device as well.

Moreover, the merchant may also opt-in as well. When this is the case, a payment application may also generate a user profile (which in this case corresponds to a merchant profile) including one or more of the information items about the merchant. This information may include some of the information collected above with respect to the customer.

In some example embodiments, a photo is required when a customer at consumer device 102 decides to use the mobile payment application 199A. As such, the customer's user profile may also include the photo and other information associated with the customer including information identifying the customer's device. The photo may be one that is taken using the consumer device, one that customer already has in the memory of his or her device, or one taken in other ways. The photo should be clear, so that the merchant can easily identify the customer.

In some example embodiments, when a user profile is created for a customer or a merchant, the payment application provides the created user profile to a server 106 that returns a user ID to the mobile payment application 199A. The server may also confirm or authenticate financial credentials of the user with a payment platform (for example, a financial institution) before returning the user ID to the payment application. The server may be a gateway that handles some of the information exchange between the customer, merchant, and payment platform, so that there is not a direct transfer of financial credentials between the customer and payment platform or the merchant and payment platform, in accordance with some example embodiments. By exchanging a minimal amount of identifying information between the consumer and merchant devices, transactions may require less information to be directly exchanged between the consumer and merchant. In some example embodiments, the consumer device 102 may send only the customer's profile photo and a minimal amount of identifying information (for example, a name, a consumer ID associated with the photo, and/or a media access control address of the device 102) to the merchant equipment 104. Similarly, only the merchant identifier may be sent from the merchant equipment 104 to the consumer device 102, in accordance with some example embodiments. The server 106 may determine how to instruct the payment platform 108 to complete the transaction by using the customer's account information to determine where funds should come from and by using the merchant identifier to determine where the funds should be deposited.

To illustrate by way of an example, when a customer walks into a merchant's store, wireless capabilities (for example, point-to-point or short-range wireless, such as Bluetooth and the like) may be activated on the consumer device. When the merchant equipment detects the wireless enabled on the consumer device (for example, detecting the Bluetooth and the like being “on”), the merchant equipment may, via for example Bluetooth, query the consumer device to determine whether the consumer device is running the payment application and/or whether the customer has a customer profile enabling usage of the payment application. Should the customer not have a customer profile, the consumer device may receive an invitation (for example, from the merchant device or a server) to create one and to participate in the payment processes associated with the payment application disclosed herein.

When the customer has a user profile and his or her consumer device is running the payment application with for example Bluetooth enabled, the merchant equipment may receive a photo of the customer (for example, the payment application on the consumer device may send the photo via Bluetooth to the merchant equipment). The merchant's payment application may then present the photo on a display, when the consumer device (and the customer carrying the device) comes within range of for example Bluetooth. Moreover, the merchant equipment may send information that identifies the merchant to the customer via the payment application, using for example Bluetooth or SMS.

To illustrate by way of an example, when the customer shops and selects one or more items to purchase, the customer (including consumer device 102) may approach the merchant's check-out where merchant equipment/device 104 is located. The customer has his or her consumer device with Bluetooth enabled on him- or herself. The merchant looks at the customer and selects a photo (which was previously provided via Bluetooth as noted above) corresponding to the customer. Next, the merchant inputs a cost for the items the customer wishes to purchase. The payment application on the merchant equipment sends the total cost of the purchase and, for example, the user ID associated with the selected photo to the server. The server then matches the identifying information associated with the photo (e.g., the consumer's name and/or user ID) and consumer device to financial credentials, for example the name of a financial institution where the consumer has an account and/or an account number for that institution. The financial credentials and the cost of the items the customer wants to purchase are sent to the payment platform for confirmation of availability of funds and transfer of the funds between the customer's account and the merchant's account.

The payment platform receives the customer's financial credentials, the amount to be paid to the merchant, and the merchant's information (for example, where to send the payment). The payment platform confirms that a payment for the indicated amount may be made (for example, that the customer has sufficient funds or credit in an account, such as a mobile payment account, credit card account, and/or any other source of funds). The payment platform then sends this confirmation to the server. The server in turn requests authorization for the transaction payment from the customer via a short message system (SMS) message to the customer's device (for example, a mobile phone or other SMS-enabled device) that is listed in his or her customer profile. In some implementations, the SMS message may be sent as an encrypted message. Additionally, or alternatively, the SMS message may be sent to the customer's device for the payment application to display to the consumer.

In response to the SMS message, the customer may give authorization for the transaction payment by responding via the payment application and/or SMS message. The SMS message sent by the customer device to authorize the transaction (which in this example is a payment to the merchant) may include a personal identification number (PIN), a password, or a combination thereof. Payment authorization may be required within a predetermined time period, such as within 1 minute, 2 minutes, 3 minutes, 30 seconds, 60 seconds, or 90 seconds, although other times may be used as well. Alternatively, or additionally, payment authorization may be required while the consumer device is within a certain range of the merchant equipment. Payment authorization may be encrypted to protect the customer's PIN and/or password. An example of a way to encrypt the PIN and/or password is described further below.

When the customer authorizes payment by sending the SMS message to the server, the server may send a message to request completion of the payment by the payment platform. The payment platform may acknowledge payment to the server, and the server may send a receipt to the merchant and/or to the customer. The receipt may be sent via SMS, although it may be sent via a data network as well.

The server may request authorization for payment from the customer, as described above, prior to sending the financial credentials, cost (or amount to be paid to merchant), and the merchant's information to the payment platform. When customer approval is sought before payment platform confirmation that the payment may be made, the payment may be denied if the payment platform determines that the customer does not have sufficient funds or credit for the payment.

FIG. 1B depicts an expanded process for user service activation/setup 110 portion. The description of FIG. 1B also refers to FIG. 1A.

Referring to FIG. 1B, the process shows the interactions between consumer device 102, merchant equipment/device 104, server 106, and payment platform 108 for the actions taken by a user. The user may be a customer or a merchant, and interactions are shown for both as a user profile is created. For a user, he or she may create a user profile using a payment application. In this case, the customer may activate his or her account through the payment application 199A, such as by entering identifying information and a password 112. The identifying information, for example user's name, address, financial credentials, government identification number, birth date, mobile phone number, a photo, and the like, and/or password may constitute activating information. The consumer device 102 including mobile payment application 199A sends this activating information to the server via short message system (SMS), although it may be sent via a data network as well. The server 106 in turn stores this information as a user profile and sends some of the stored information to the payment platform for verification 116. The payment platform 108 responds by verifying the information, and the server 106 sends a message that the profile is active and verified to the consumer device at 120.

The merchant can also create a user profile that is confirmed by a payment platform. Additionally, the merchant device may use the payment application 199C to register the merchant for services associated with the payment application, particularly identifying customers based upon their photos 122. The merchant equipment may send device identifying information to the server, such as a media access control MAC address (which may be associated with the Bluetooth transceiver), universally unique identifier, and/or the like. The server in turn may record this information and return a simplified identifier that may be used with the payment application 124. This information may be sent via SMS or a data network.

The customer may complete the abstraction of his or her information by associating a photo taken using his or her consumer device and the consumer device's Bluetooth MAC address (or any other type of identifier and/or address for example) to his or her user profile 130. The photo and Bluetooth MAC address may be sent to the server for storage and association with the customer's profile 134. Confirmation of this association may be sent back to the consumer device 130.

All of the data sent in setting up user profiles may be sent using short message system (SMS) or a data network (for example, the Internet, a local area network, a mesh network, and the like).

FIG. 1C depicts the interactions 140 between a consumer device 102, merchant equipment 104, server 106, and payment platform 108 as a customer makes a purchase using the payment application that associates a customer's user profile with his or her photo and device identifying information (for example, Bluetooth MAC address). The description of FIG. 1C also refers to FIG. 1A.

Referring to FIG. 1C, the interaction shown 140, begins with the customer entering a merchant's store with a payment application running and Bluetooth enabled on his or her consumer device, as in 142. A connection is established between the consumer device and a merchant equipment 144 when the two devices are within range of the Bluetooth transceivers. The merchant equipment running the payment application may share its Bluetooth identifier, and may request the customer to share his or her user profile if he or she is a new customer, as in 148. The consumer device may send the customer's photo to the merchant equipment 146 once profile sharing is enabled.

The merchant may observe the customers who have shared profiles over Bluetooth on his merchant equipment 150 and try to match photos to actual persons. Once the customer has completed his or her shopping, the customer may approach the check-out in the shop and indicate that he or she would like to use the payment method associated with the payment application that verifies identification by photos as in 160. Any information required for the transaction that was not previously sent may be sent via Bluetooth 162 between the consumer device and the merchant equipment. The total cost for the goods and/or services may be provided to the customer either visually or verbally. At this point, the merchant (or the cashier of the shop) may select the photo corresponding to the customer and input the cost of the transaction at 164.

The merchant equipment may send a payment request to the server as in 170. The server may request authorization from the customer via SMS as at 172. The customer may send authorization via SMS or a data network to the server at 174. With this authorization, the server may send information about the customer, merchant, and transaction amount to the payment platform 108 and receive confirmation of the transaction at 176. The server may send a receipt to the merchant as in 178 and to the customer at 180 after receiving confirmation of the transaction.

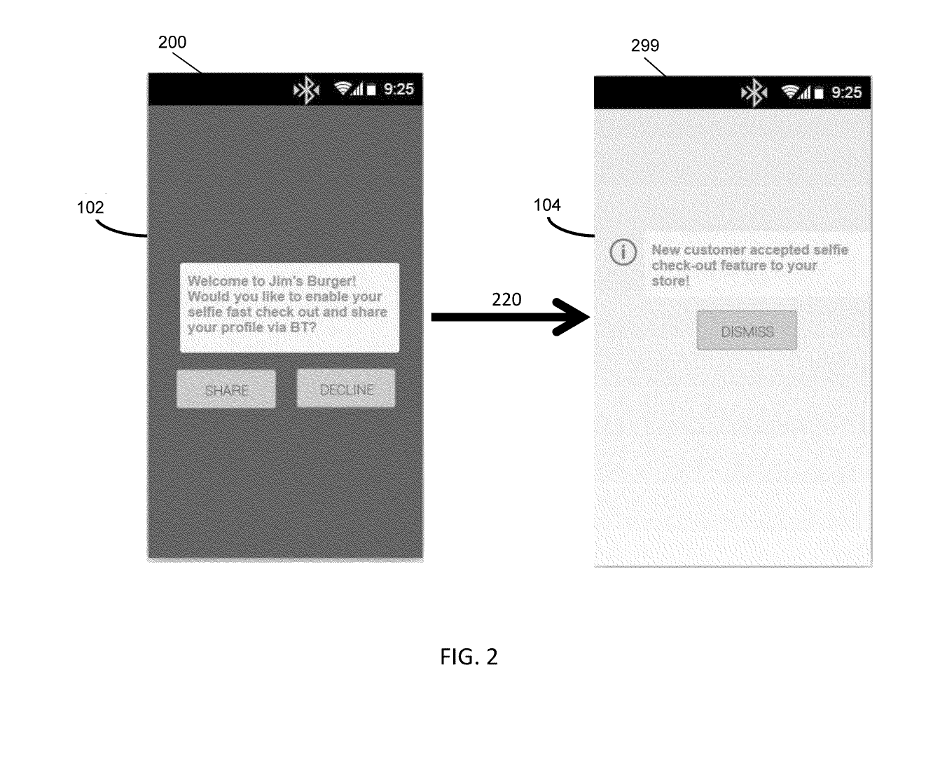

FIG. 2 depicts a view 200 that may be displayed on a consumer device 102 and a view 299 that may be displayed on a merchant equipment 104 when a new customer enters a merchant's shop for the first time. The view 200 on the consumer device 102 may prompt the customer to share or create a profile. If the customer shares his or her profile, the consumer device sends it via a wireless link (for example, Bluetooth 220 and the like) to the merchant equipment. The view 299 on the merchant equipment may alert the merchant to the presence of a new customer. In this way, the merchant may familiarize him- or herself with the photo of the new customer prior to a financial transaction, if desired.

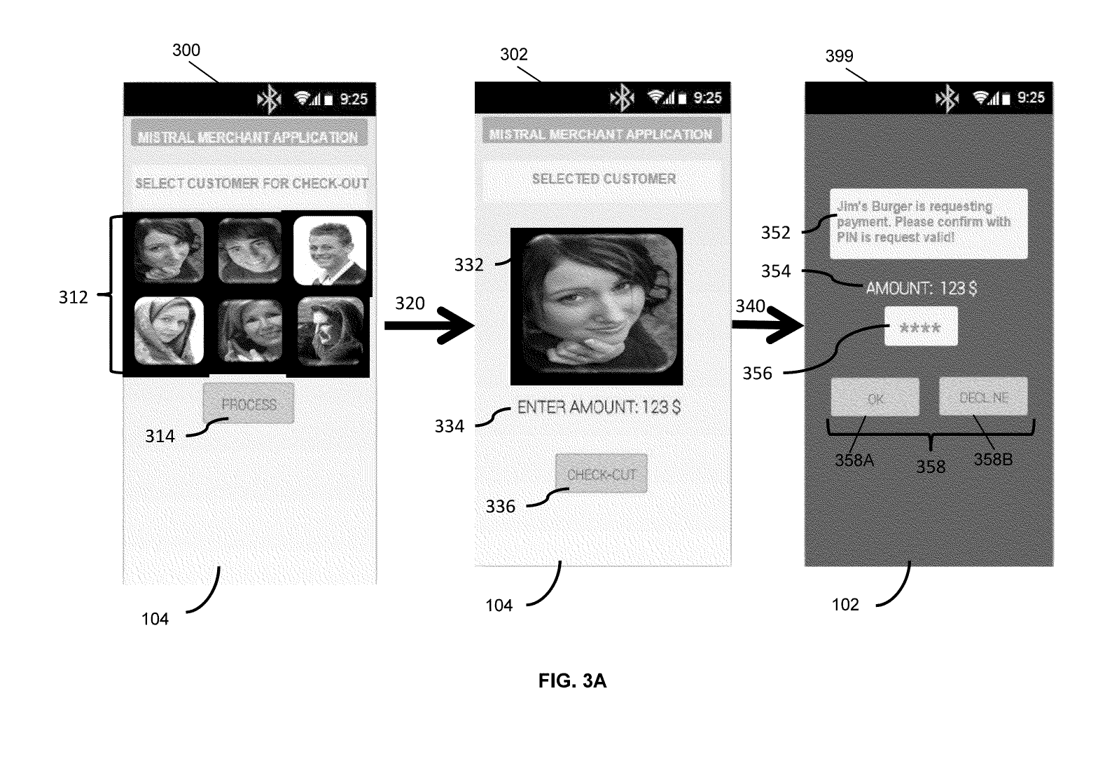

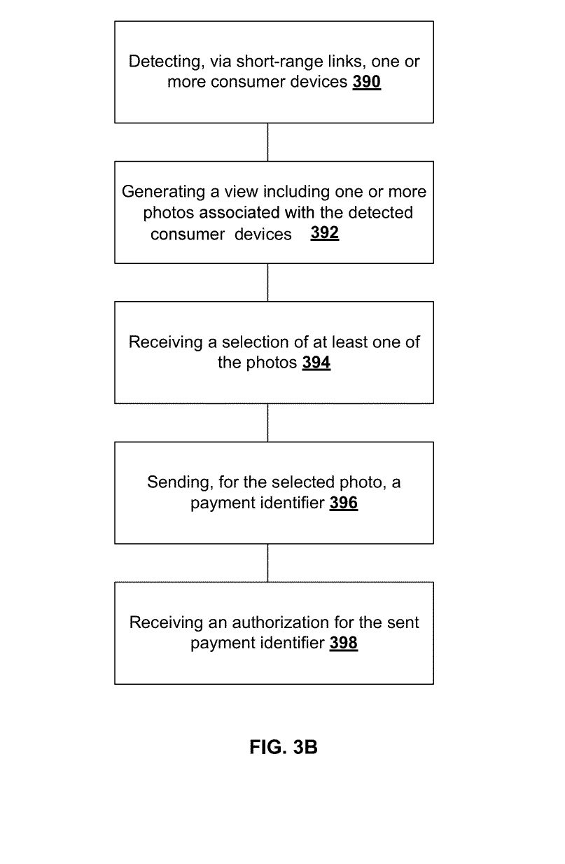

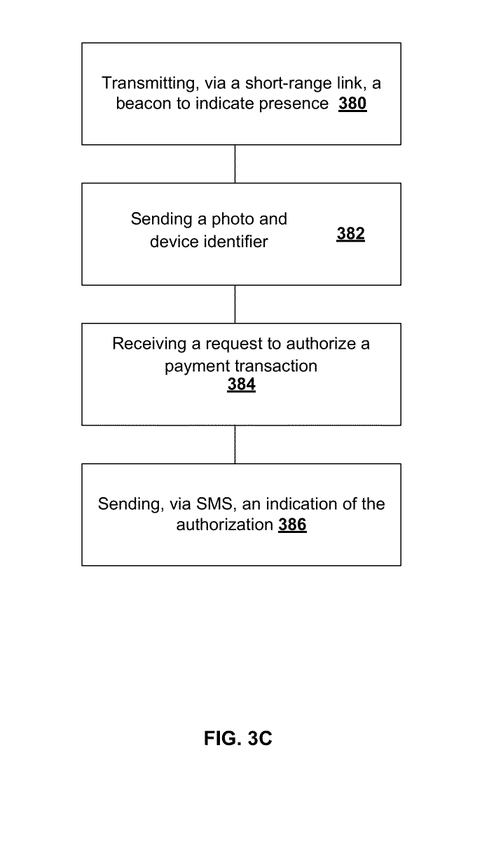

FIG. 3A depicts views that may be displayed on a merchant equipment 104, and on a consumer device 102 during a customer's check-out or purchase transaction in accordance with some embodiments described herein. The merchant equipment 104 may present photos 312 of all of the customers present in the shop who have shared their user profiles with the merchant. The view 300 may include photos of customers 312 (which may be using consumer devices, such as consumer device 102). The view 300 may also include an icon 314 (labeled “Process”), which when selected allows the merchant to proceed 320 to another view 302 after selecting a photo 312. The view 302 presented to the merchant on the merchant equipment 104 may include a larger view of the customer's photo 332, an input icon 334 for the amount of the transaction being tendered, and checkout icon 336. Once the merchant has entered the amount at 334 and selected checkout 336 after verifying that the consumer making the purchase matches the picture 332, the merchant equipment sends the information via data network or SMS to a server 340. The sent information may include the cost of the purchase, the customer's name, the customer's user ID assigned by the server, and/or the media access control address of the consumer device.

In some embodiments, the customer's photo 332 may be associated with a code, such an encrypted identifying number including a cryptographic hash function value. The code, for example an unique hash function value, may be associated with the customer's photo 332 when the consumer creates a user account with the payment application and initially stores his or her photo on the server. In some embodiments, the customer's photo 332 may be associated with other customer specific information, such as the media access control (MAC) address of the consumer's device when the photo 332 is uploaded to the server. When the merchant views the customer's photo 332 on the merchant equipment 104, the photo may be supplied by the server in exchange for identifying information received from the consumer device. The identifying information received by the merchant equipment 104 from the consumer device may include a code (e.g., a unique hash function value, a MAC address, and/or the like).

Upon receipt of cost and customer's identifying information from the merchant device, server 106 requests authorization for the transaction from the customer. The customer may be presented with an authorization view 399 on his or her consumer device 102, such as a mobile phone and the like. The authorization view 399 may include information regarding the vendor and transaction 352, the amount of the transaction 354, an input for a PIN or password 356, and/or icons for authorizing 358A (labeled “OK”) the mobile payment transaction or declining 358B the mobile payment transaction.

Though short-range communications are described herein in terms of Bluetooth, other short-range radio access technologies/communication protocols may be used to identify devices and exchange information.

FIG. 3B depicts a process at a merchant equipment for mobile payment processing based on photos, in accordance with some example embodiments.

At 390, the merchant equipment detects one or more consumer devices via short-range links or communication. A customer may enter the merchant's store with Bluetooth enabled on his or her consumer device. When the customer's device enters the store with Bluetooth enabled and running the mobile payment application, the merchant equipment may detect the consumer device.

At 392, a mobile payment application generates a view on the merchant equipment for presentation on a display that includes a photo of the customer associated with each of the one or more consumer devices.

The merchant recognizes the customer who approaches checkout and selects the corresponding photo from those displayed by the mobile payment application. At 394, the mobile payment application on the merchant equipment receives an indication of that selection of at least one of the photos.

At 396, the merchant equipment sends a payment identifier to a server. The payment identifier may include information associated with the selected photo, including the customer's name and/or user ID, as well as the final amount of the transaction.

At 398, the merchant equipment receives notification from the server that the customer has authorized the transaction associated with the payment. The authorization notification may be a receipt from the server or a receipt from a payment platform that communicates with the server.

FIG. 3C depicts a process at a consumer device for mobile payment processing based on photos, in accordance with some example embodiments.

At 380, the consumer device transmits a beacon or other signal to indicate its presence. This notification signal may be sent via a short-range link, including Bluetooth. A nearby merchant device may receive the beacon or signal from the consumer device.

At 382, the consumer device sends a photo and an identifier, such as a customer identifier, a device identifier, and the like, to a merchant device via a mobile payment application. The device identifier may be a media access control address. The photo may be associated (at server 106) with a customer profile for a mobile payment application that runs on the consumer device.

After the customer decides to make a purchase, approaches a store check-out, and initiates a transaction with a merchant, the consumer device may receive, from server 106 or merchant device 104, a request to authorize a payment transaction, at 384.

The customer may enter an indication of authorization for the payment transaction on the consumer device, and in turn, the consumer device may send the indication of authorization via a short messaging system (SMS), at 386. The consumer device may send the indication of authorization to server 106, a payment platform in communication with the server, or both the server and payment platform (although the indication may be sent via merchant device 104 as well). The indication of authorization may be a text message that includes a password, a simple word, or a personal identification number (PIN). The simple word may include “yes,” “no,” “accept,” or “reject.”

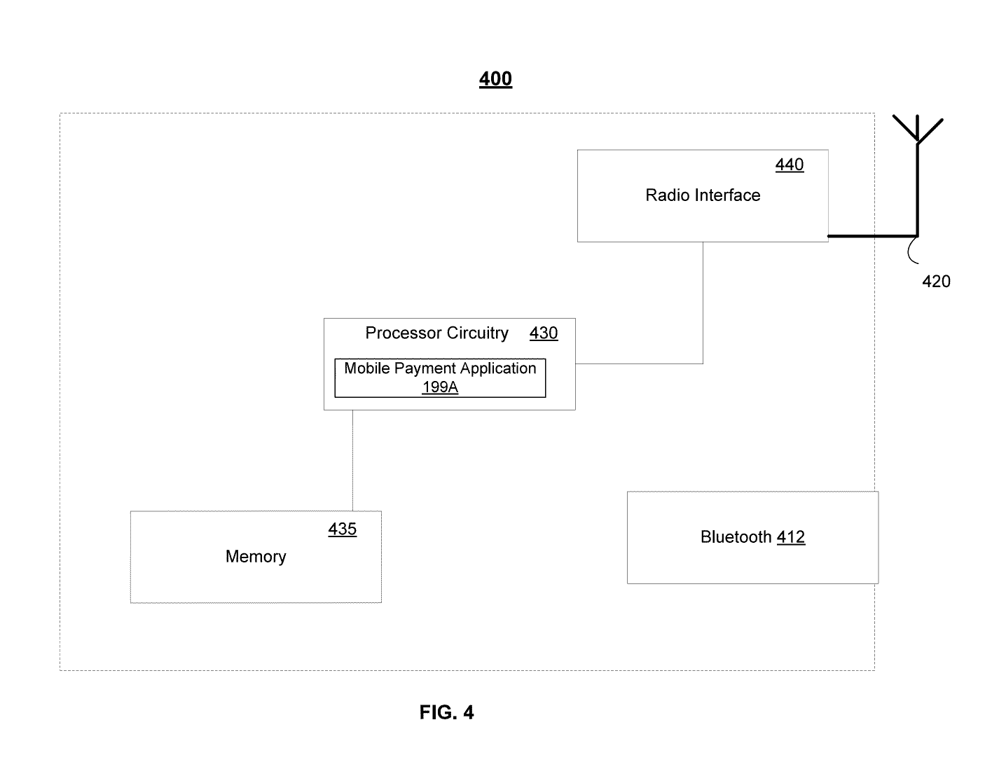

FIG. 4 depicts a block diagram of a radio 400, such as consumer device 102 and/or merchant device 104. The consumer device and/or merchant device may include a mobile payment application 199A that handles the photos and processes disclosed herein (see signaling diagrams at FIGS. 1B and 1C) and a short-range transceiver, such as Bluetooth 412.

The radio 400 may also include an antenna 420 for receiving a downlink and transmitting via an uplink. The radio 400 may also include a radio interface 440, which may include other components, such as filters, converters (e.g., digital-to-analog converters and/or the like), symbol demappers, signal shaping components, an Inverse Fast Fourier Transform (IFFT) module, and/or the like, to process symbols carried by a downlink or an uplink. In some implementations, the radio may also be compatible with WiFi, Bluetooth, GERAN, UTRAN, E-UTRAN, first generation (1G) communication protocols, second generation (2G or 2.5G) communication protocols, third-generation (3G) communication protocols, fourth-generation (4G) communication protocols and/or any other standards, radio access technologies, and specifications as well. Moreover, the radio 400 may be configured to support messaging, such as SMS messages. The radio 400 may further include at least one data processor, such as data processor 430 (e.g., a microprocessor and/or the like) for controlling radio 400 and for accessing and executing program code stored in memory 435. For example, memory 435 may include code for performing one or more of the operations associated with consumer device and/or merchant device including the processes 110, 140, and hosting the mobile payment application.

The following describes an encryption approach which may be used in some example embodiments. Specifically, a mobile payment application at the consumer device 102 and/or merchant device 104 may receive a key collection including a plurality of key parts from a server, such as gateway 106 and/or a token provider. These key parts may include key values and indexes. A key value represents a portion of a symmetric key, and an associated index identifies the key value in a certain key collection. For example, when information is received for secure transmission by the mobile application via a link, the mobile payment application may select 2 key parts (i.e., key values and corresponding indexes) from each of the 4 key collections, although other quantities of key values and key collections may be used as well. The mobile payment application may then combine the selected key values to form a symmetric key, which is then used to encrypt the received information. The mobile payment application may then generate a short message service (SMS) message carrying at least a header portion and a payload portion. The payload may include the encrypted information (for example, confidential payment information associated with consumer 102), and the header may represent the indexes identifying which key values were selected to form the symmetric key. The mobile application may then send the SMS message to a server, where the SMS message is decrypted. In some example embodiments, the symmetric key is dynamically generated in the sense that each piece of information, such as financial transaction information, requiring transmission to the server is encrypted with a unique, one-time key. Moreover, the key collections at the mobile application may be updated with another key collection, when the possible key combinations have been exhausted, when the keys have been compromised, and/or any other time new key collections are desired. The subject matter disclosed herein may, in some example implementations, provide symmetric encryption for SMS communication and the like using a dynamic, one-time use symmetric key formed from key parts shared by the sender and receiver.

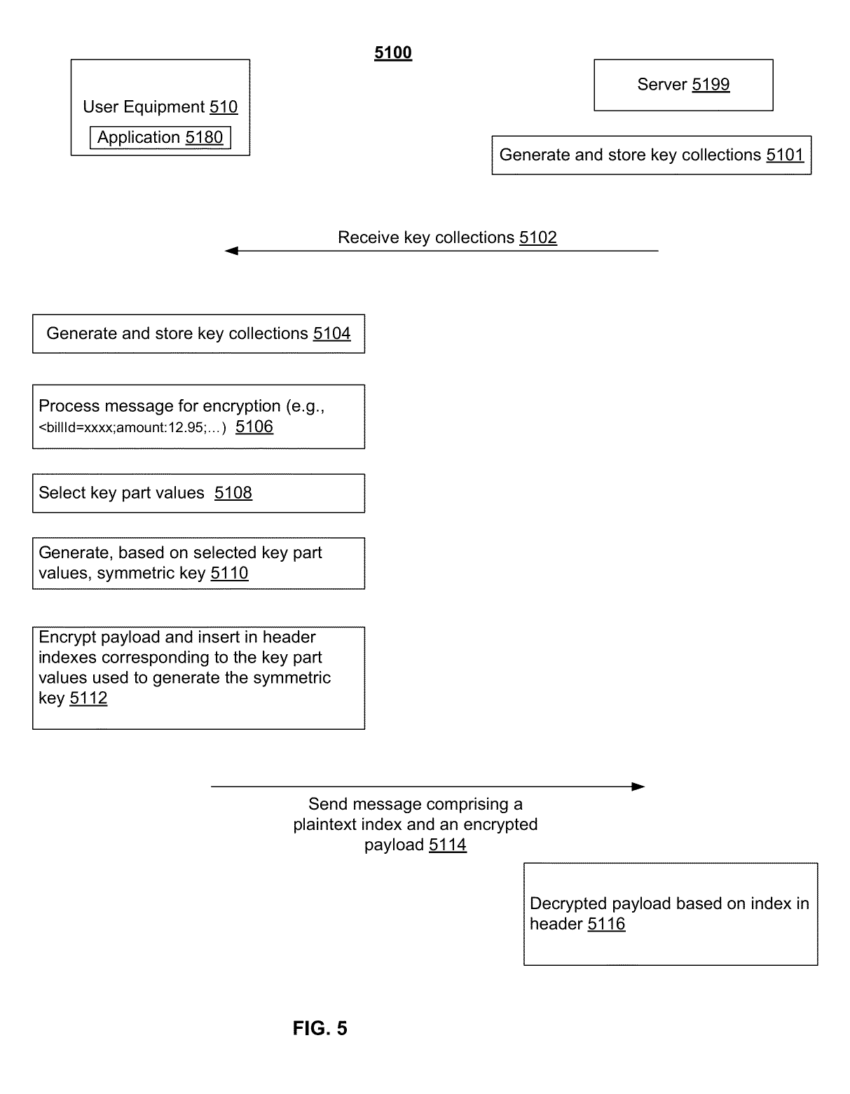

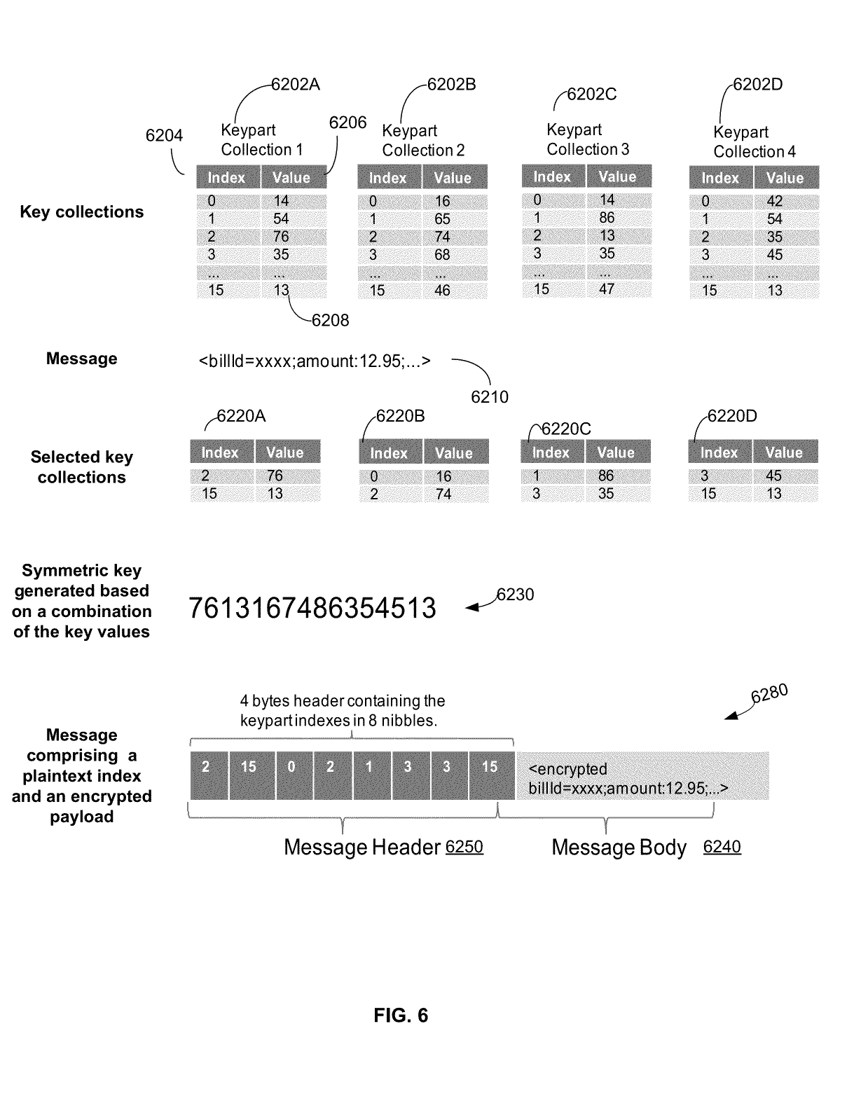

FIG. 5 depicts an example process 500 for providing secure transactions, in accordance with some example embodiments. The description of FIG. 5 also refers to FIG. 1 and FIG. 6.

In some exemplary embodiments, consumer and/or merchant devices (referred to herein after as user equipment) 510 may be implemented as a mobile wireless device. The user equipment 510 may be referred to as, for example, a mobile station, a mobile unit, a subscriber station, a wireless terminal, a tablet, a smartphone, a cell phone, and/or the like. The user equipment may be implemented as, for example, a wireless handheld device, a wireless plug-in accessory, and/or the like. In some cases, the user equipment may include a data processor, a computer-readable storage medium (e.g., memory, storage, and/or the like), a radio access mechanism, and/or a user interface. Moreover, the user equipment may include one or more applications, such as application 5180 stored as code in memory and executable by a data processor. Application 5180 may be implemented as mobile payment application 199A-C or as any other application as well. Furthermore, user equipment may be configured to send SMS messages to an SMS aggregator (or SMSC) via a wireless access point, such as a base station, a WiFi access point, and/or the like, interfaced to the public land mobile network.

Server 5199 may include a data processor and a computer-readable storage medium (e.g., memory, storage, and/or the like). In some example embodiments, server 5199 may be implemented as server/gateway 106 having a first interface to a SMS aggregator (and/or SMS provider) and a second interface to other systems, such as a token provider, payment platform 108, and/or the like.

At 5101, server 5199 may generate and store key collections. For example, server 5199 may comprise a data processing device configured to generate key collections. Specifically, server 5199 may randomly generate and store key collections, each of which includes indexes and corresponding key values. The key values represent portions of a symmetric key, and when some of these portions are combined, the combined portions form a symmetric key used to encrypt information using a symmetric encryption engine, such as AES and/or the like. In some example embodiments, server 5199 includes a security module that generates, or receives from a key generator, 4 key collections, as depicted at FIG. 6 (although other quantities may be used as well). These key collections may then be securely stored at server 5199.

The example of FIG. 6 depicts 4 key collections 6202A-D, and the key collections include indexes 6204 and key values 6206. Each of the indexes uniquely maps, and thus identifies, a certain key value. In some example embodiments, each of the key collections includes 16 key parts, each comprising an index and a key value. For example, these 16 key parts at key collection 6202A comprise index 0 and key value 14, index 1 and key value 54, index 2 and key value 54, and so forth through index 15 and corresponding key value 13. Moreover, any key value can be identified uniquely based on its collection and index. For example, key value 13 (at 6208) can be uniquely identified by specifying the key collection and index, which in this example is key collection 1 and index 15 (e.g. 1, 15). In any case, the key values can be combined by, for example, concatenating the key values to form a symmetric key as further described below. In some example embodiments, additional layers of security may be provided so long as both endpoints are aware of those additional layers to enable processing. For example, key values may be built in other ways from the shared key collection and index information so long as both endpoints are aware of the way being used.

Referring again to FIG. 5 at 5102, once the key collections are generated, server 199 may store the key collections in a secure manner, such as using a dedicated secure storage mechanism including, for example, a hardware security module (HSM), although other locations may be used as well.

At 5104, the server 5199 may send the key collections generated and stored at 5102 to user equipment, such as merchant device 104 and/or consumer device 102. For example, server 5199 may share the key collections 6202A-D with user equipment including mobile payment application 5180 by sending the key collections 6202A-D. In some example embodiments, the key collections may be sent via at least a wireless link carrying an encrypted SMS message as disclosed herein (e.g., an index and an encrypted payload, using for example AES, as disclosed herein), although the key collections may be sent in other ways as well. For example, when user equipment 510 (for example, consumer device 102 and/or merchant device 104) connects to server 5199 for the first time, user equipment 510 may obtain the initial key collections (and/or other software and/or data for the application 5180) via a secure connection using, for example, using SSL or key collections can be shared by leveraging public-private key and temporary symmetric key approach. After that initial key collection delivery, the encrypted SMS messages disclosed herein may be used to share the key collections.

Once the user equipment 510 receives the key collections, user equipment 510 may then store at 5104 the key collections. Moreover, the application 5180 and/or user equipment 510 may receive key collections 6202A-D and then store the key collections 6202A-D securely using, for example, local encrypted, or otherwise secure, storage.

At 5106, a message may be processed for encryption, in accordance with some example embodiments. For example, mobile payment application 5180 and/or user equipment 510 may have a message for transmission, such as a bill pay message (“<billId=xxxx;amount:12.95>”) 6210 at FIG. 6. In this example, the message represents a financial transaction to be carried by an SMS message securely, and, in particular, a user of user equipment 510 submitting bill payment to server 5199. As noted above, the encryption may be used in some example embodiments for out-of-band verification as disclosed herein.

At 5108, the application 5180 at user equipment 510 may select key parts. For example, application 5180 may randomly select 2 key parts from each collection, as depicted at 6220A-D at FIG. 6.

At 5110, a symmetric key may be generated, based on the selected key parts. For example, user equipment 510 and/or application 5180 may select the key values from each of the selected key parts 6220A-D and then combine those key values to form a symmetric key. Referring again to FIG. 6, the generated key is 7613167486354513 (at 6230). This generated key represents the concatenation of the selected key values, 76 and 13, from the first collection, the key values, 16 and 74, from the second collection, the key values, 86 and 35, from the third collection, and the key values, 45 and 13, from the fourth collection.

In some example embodiments, the generated symmetric key may also be hashed using user equipment 510's Mobile Station International Subscriber Directory Number (MSISDN), a Bluetooth universally unique identifier (UUID), or any other identifier (which would also be known by the server 5199), a media access control (MAC) address of the user equipment, an IMSI of the user equipment, an IMEI of the user equipment, an MEID of the user equipment, electronic serial numbers (ESNs), account identifiers (for example, GSM account information), a SIM phone number, platform identifier (for example, operating system identifier), SIM serial number, as well as any other user equipment and/or SIM-based identifiers including a hash of one or more identifiers.

At 5112, the symmetric key may be used to encrypt the message payload, and a plaintext header including indexes may be appended to the payload. For example, the message payload, “<billId=xxxx;amount:12.95>”, may be encrypted symmetrically using the key generated at 5110. The indexes for the selected key collections may then be combined and inserted into a header. This header may be in plaintext, i.e., not encrypted by the symmetric key. Referring again to FIG. 6, the message body 6240 includes the encrypted payload of “<billId=xxxx;amount:12.95>.” The message header 6250 includes the indexes for the selected key values contained in the symmetric key, so that the index uniquely identifies all of the key value pieces used to form the entire symmetric key 6230. For example, the message header 6250 includes indexes 2 and 15 from the first collection 6220A, indexes 0 and 2 from the second collection 6220B, indexes 1 and 3 from the third collection 6220C, and indexes 3 and 15 from the fourth collection 6220D. Because the message header 6230 includes the ordered indexes from each key collection 6220A-D, the server 5199 will be able to determine symmetric key 6230 based on the plaintext index contained in the message header 6250. In some example embodiments, the symmetric encryption is AES, although other symmetric encryption techniques may be used as well.

Although the message header 6250 at FIG. 6 includes the indexes in a predetermined order corresponding to the collections 6202A-D, the indexes may be placed in the header in other orders as well. When this is the case, server 5199 may be configured to know the index placement technique used at the user equipment to access the key values in the key collections.

In some example embodiments, the message body 6240 may also be signed using, for example, a hash as noted above. This hash may be implemented as a Secure Hash Algorithm (SHA) and/or MD5, although other hash techniques may be used as well.

In the example of FIG. 6, as symmetric key creation relies on 4 key collections from which 2 key parts among 16 are randomly selected, the amount of unique combinations is 262,144 (i.e., 4 times 2¹⁶). Moreover, the header 6250 may, in some example embodiments, contain 4 bytes reserved to receive the 8 indexes of the key parts necessary to re-generate the symmetric key for decrypting the message body 6240. Each of these indexes fit into one nibble (i.e., a half-byte whose value is between 0-15), so the 8 indexes of the key parts can be set using only 4 bytes (i.e., 8×½ byte). Although some of the examples described herein refer to specific quantities of key values, key collections, and indexes, other quantities may be implemented as well.

At 5114, the message may be sent to server 5199. Referring again to FIG. 6, user equipment 510 may send message 6280 including message header 6250 and message body 6240 to server 5199. Moreover, message 6280 may be sent via SMS or any other connectivity channel between client and server. Specifically, user equipment 510 may provide message 6280 to an SMS interface at the user equipment 510 for sending the message 6280 via SMS. The server 5199 may have an interface to an SMS provider, which provides the SMS message 6280 to server 5199. In this example, the server 5199 may obtain the user equipment's MSISDN from the SMS service provider and determine the key parts used based on the header 6250 carried by the SMS message.

At 5116, server 5199 may decrypt the message based on the index in the header. For example, server 5199 may read the header comprising 2, 15, 0, 2, 1, 3, 3, and 15 and then access the key collections to identify the key values forming the symmetric key (e.g., 7613167486354513) used by user equipment 510 to send the message. Using the symmetric key, server 5199 may then decrypt the message into plaintext. When hashing is used, the server 5199 may hash the symmetric key before decrypting the message.

In some example embodiments, the server 5199 may send an acknowledgement message to user equipment 510 to confirm receipt of the message received by server 5199 at 5102. This acknowledgement may be sent as an SMS message. Moreover, this SMS acknowledgement message may carry a payload encrypted using the same key used to encrypt the payload of the message received at 5112, although a different key may be generated using the key collections.

In some example embodiments, each generated symmetric key is used only during one request/response sequence before it is discarded. When this is the case, the user equipment 510 may store and keep a record of all the used key parts combinations. Moreover, the record may allow server 5199 to reject any incoming messages that use an already-used symmetric key. Furthermore, once a certain amount of key parts combinations have been used or when the key collections (or portions thereof) have been compromised, server 5199 may, in some example embodiments, decide to renew the key collections by resending a new set of key collections at 5102.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed is:

1. A method comprising:
detecting, by a merchant equipment including a mobile payment application, one or more consumer equipment;
generating, by the merchant equipment including the mobile payment application, a view including one or more photos sent by the detected one or more consumer equipment, wherein each of the one or more photos represent a corresponding user of the detected one or more consumer equipment;
receiving, by the merchant equipment including the mobile payment application, a selection of one of the one or more photos; and
sending, by the merchant equipment including the mobile payment application, payment information corresponding to the selected photo to enable authorization of a mobile payment by a user corresponding to the selected one of the one or more photos.

2. The method of claim 1, wherein the sending comprises sending via a short messaging service the payment information. The method of claim 1, further comprising:
receiving, by the merchant equipment including the mobile payment application, identifying information from the one or more consumer equipment.

4. The method of claim 3, wherein the identifying information is received via short-range wireless communication.

5. The method of claim 4, wherein the short-range wireless communication comprises at least one of Bluetooth, Bluetooth Low Energy, Near Field Communications, or WiFi.

6. The method of claim 1, further comprising:
receiving, by the merchant equipment including the mobile payment application, confirmation of payment via a short messaging service.

7. An apparatus comprising at least one processor and at least one memory including computer program code, the at least one memory and the computer program code configured to, with the processor, cause the apparatus to at least:
detect, by the apparatus including a mobile payment application, one or more consumer equipment;
generating, by the apparatus including the mobile payment application, a view including one or more photos sent by the detected one or more consumer equipment, wherein each of the one or more photos represent a corresponding user of the detected one or more consumer equipment;
receiving, by the apparatus including the mobile payment application, a selection of one of the one or more photos; and
sending, by the apparatus including the mobile payment application, payment information corresponding to the selected photo to enable authorization of a mobile payment by a user corresponding to the selected one of the one or more photos.

8. The apparatus of claim 7, wherein the sending comprises sending via a short messaging service the payment information.

9. The apparatus of claim 7, wherein the apparatus is further configured to at least receive identifying information from the one or more consumer equipment.

10. The apparatus of claim 9, wherein the identifying information is received via short-range wireless communication.

11. The apparatus of claim 10, wherein the short-range wireless communication comprises at least one of Bluetooth, Bluetooth Low Energy, Near Field Communications, or WiFi.

12. The apparatus of claim 7, wherein the apparatus is further configured to at least receive confirmation of payment via a short messaging service.

13. The apparatus of claim 7, wherein the apparatus comprises a merchant equipment.

14. A non-transitory computer-readable storage medium comprising code, which when executed by at least one processor circuitry causes operations comprising:
detecting, by a merchant equipment including a mobile payment application, one or more consumer equipment;
generating, by the merchant equipment including the mobile payment application, a view including one or more photos sent by the detected one or more consumer equipment, wherein each of the one or more photos represent a corresponding user of the detected one or more consumer equipment;
receiving, by the merchant equipment including the mobile payment application, a selection of one of the one or more photos; and
sending, by the merchant equipment including the mobile payment application, payment information corresponding to the selected photo to enable authorization of a mobile payment by a user corresponding to the selected one of the one or more photos.

15. A method comprising:
signaling, by a consumer equipment including a mobile payment application, a merchant equipment, to indicate a presence of the consumer equipment;
sending, by the consumer equipment including the mobile payment application, a photo to the merchant equipment, wherein the photo represents a user of the consumer equipment; and
receiving, by the consumer equipment including the mobile payment application, a request for authorization of a mobile payment, wherein authorization is requested of the user of the consumer equipment that corresponds to the sent photo.

16. The method of claim 15, wherein the signaling comprises responding to a request for information from the merchant device.

17. The method of claim 15, wherein the signaling is carried out via a short-range radio access technology.

18. The method of claim 17, wherein the short-range radio access technology comprises at least one of Bluetooth, Bluetooth Low Energy, Near Field Communications, and WiFi.

19. The method of claim 15, wherein the request for authorization is received via a short messaging service (SMS).

20. The method of claim 15 further comprising:
sending an authorization message to a mobile payment server to enable the authorization of the mobile payment.

21. An apparatus comprising at least one processor and at least one memory including computer program code, the at least one memory and the computer program code configured to, with the processor, cause the apparatus to at least:
signal, by a apparatus including a mobile payment application, a merchant equipment, to indicate a presence of the apparatus;
send, by the apparatus including the mobile payment application, a photo to the merchant equipment, wherein the photo represents a user of the apparatus; and
receive, by the apparatus including the mobile payment application, a request for authorization of a mobile payment, wherein authorization is requested of the user of the apparatus that corresponds to the sent photo.

22. The apparatus claim 21, wherein the signaling comprises responding to a request for information from the merchant device.

23. The apparatus of claim 21, wherein the signaling is carried out via a short-range radio access technology.

24. The apparatus of claim 23, wherein the short-range radio access technology comprises at least one of Bluetooth, Bluetooth Low Energy, Near Field Communications, and WiFi.

25. The apparatus of claim 21, wherein the request for authorization is received via a short messaging service (SMS).

26. The apparatus of claim 21, wherein the apparatus is further configured to at least send an authorization message to a mobile payment server to enable the authorization of the mobile payment.

27. The apparatus of claim 21, wherein the apparatus is further configured to at least register with a mobile payment server by at least providing, via the payment application on the apparatus, identifying information and a password, the identifying information comprising at least one of name, address, financial credentials, government identification number, birth date, mobile phone number, and a photo of a user of the apparatus.

28. The apparatus of claim 21, wherein the apparatus comprises consumer equipment.

29. A non-transitory computer-readable storage medium comprising code, which when executed by at least one processor circuitry causes operations comprising:
signaling, by a consumer equipment including a mobile payment application, a merchant equipment, to indicate a presence of the consumer equipment;
sending, by the consumer equipment including the mobile payment application, a photo to the merchant equipment, wherein the photo represents a user of the consumer equipment; and
receiving, by the consumer equipment including the mobile payment application, a request for authorization of a mobile payment, wherein authorization is requested of the user of the consumer equipment that corresponds to the sent photo.
